(19) United States
(12) Patent Application Publication
(10) Pub. No.: US 2016/0232213 A1
(43) Pub. Date: Aug. 11, 2016

(54) Information Processing System, Information Processing Method, and Recording Medium with Program Stored Thereon

(71) Applicant: NEC CORPORATION, Tokyo (JP)

(72) Inventors: Satoshi MORINAGA, Tokyo (JP); Ryohei FUJIMAKI, Tokyo (JP)

(73) Assignee: NEC Corporation, Tokyo (JP)

(21) Appl. No.: 15/024,802

(22) PCT Filed: Sep. 11, 2014
(86) PCT No.: PCT/JP2014/004706

§ 371 Date: Mar. 24, 2016

Related U.S. Application Data
(60) Provisional application No. 61/883,672, filed on Sep. 27, 2013.

(51) Int. Cl. G06F 17/30

(52) U.S. Cl. CPC G06F 17/30539; G06F 17/30536

(57) ABSTRACT

This invention helps improve the precision of data mining. This information processing system is provided with an attribute-generating means and an evaluating means, as follows. From among a plurality of inputted attributes, the attribute-generating means selects a combination of attributes to serve as operands for a function that defines an operation that takes a plurality of operands. The attribute-generating means applies said function to that combination of attributes to generate a new attribute that is the result of applying that function to that combination of attributes. The evaluating means inputs said new attribute to an analysis engine, which executes an analysis process on the basis of the attribute, and determines whether or not information outputted by said analysis engine satisfies a prescribed requirement.

### TECHNICAL FIELD

The present invention relates to a technology of supporting data mining.

### BACKGROUND ART

Data mining is a technology of finding useful knowledge having been unknown so far from a large amount of information. As an actual example in which useful knowledge is obtained using data mining, an example in which sales data possessed by a major supermarket chain has been analyzed is known. As a result of analyzing the sales data, a knowledge that “a customer having purchased diapers tends to purchase beer at the same time” has been obtained. It is possible for the supermarket chain to make use of the knowledge to increase sales by taking measures such as measures “not to reduce prices of diapers and beer at the same time”.

A process of applying data mining to a specific example as described above can be roughly classified into three stages as described below.

A first stage (step) is a “pre-processing stage.” The “pre-processing stage” transforms, to cause a data mining algorism to efficiently function, by processing a feature to be input to a device or the like operating in accordance with the data mining algorism, the feature into a new feature.

A second stage is an “analysis processing stage.” The “analysis processing stage” inputs a feature to the device or the like operating in accordance with the data mining algorism and obtains an analysis result that is an output of the device or the like operating in accordance with the data mining algorism.

A third stage is a “post-processing stage.” The “post-processing stage” converts the analysis result to an easily viewable graph, a control signal to be input to another device, or the like.

In this manner, to obtain useful knowledge using data mining, it is necessary to appropriately execute the “pre-processing stage.” A work of designing what procedures should be carried out as the “pre-processing stage” depends on knowledge of a skilled engineer (data scientist) in analysis technology. The design work of the pre-processing stage is not sufficiently supported by information processing technology and still depends to a large extent on trial and error through manual procedure by the skilled engineer.

NPL 1 discloses one example of software with which data mining is implemented. NPL 1 provides a function that supports a selection of a feature suitable for implementing of a desired task (analysis processing). This function is referred to also as a “feature selection.”

### CITATION LIST

### Non Patent Literature

[NPL 1] “WEKA”, [online], [retrieved on Sep. 5, 2013], the Internet <URL: http://www.cs.waikato.ac.nz/ml/weka/>

### SUMMARY OF INVENTION

### Technical Problem

Suppose that an operator performs data mining using the software disclosed by NPL 1. In this case, it is not always possible for the operator to obtain an accurate analysis result. The reason is that the software disclosed by NPL 1 merely selects a feature for obtaining an accurate analysis result among features prepared in advance. In this manner, there is a limitation, that is, the software disclosed by NPL 1 can only output a solution selected from the features prepared in advance. Therefore, when a feature by which an accurate analysis result is obtained is not included in the features prepared in advance, it is not possible for the operator to obtain an accurate analysis result.

One of the objects of the present invention is to provide an information processing system and the like contributing to accuracy improvement in analysis processing.

### Solution to Problem

A first aspect of the present invention is an information processing system including: feature construction means for selecting, for a function that defines an operation taking a plurality of operands, a combination of features that are capable being the plurality of operands from a plurality of features which are input, and constructing, by applying the function to the combination of the features, a new feature that is a result obtained by applying the function to the combination of the features; and test means for inputting the new feature to an analysis engine that executes analysis processing on a basis of the features, and testing whether information output by the analysis engine satisfies a predetermined requirement.

A second aspect of the present invention is an information processing method performed by a computer capable of accessing function storage means storing a function defining an operation taking a plurality of operands, the method including: acquiring the function from the function storage means; feature construction means for selecting a combination of features that are capable of being the plurality of operands from a plurality of features which are input, and constructing, by applying the function to the combination of the features, a new feature that is a result obtained by applying the function to the combination of the features; and inputting the new feature to an analysis engine that executes analysis processing on a basis of the features, and testing whether information output by the analysis engine satisfies a predetermined requirement.

A third aspect of the present invention is a computer-readable recording medium storing a program causing a computer capable of accessing function storage means storing a function defining an operation taking a plurality of operands to execute: processing of acquiring the function from the function storage means; processing of selecting a combination of features that are capable of being the plurality of operands from a plurality of features which are input, and constructing, by applying the function to the combination of the features, a new feature that is a result obtained by applying the function to the combination of the features; and processing of inputting the new feature to an analysis engine that executes analysis processing on a basis of the features, and testing whether information output by the analysis engine satisfies a predetermined requirement.

An object of the present invention is achieved also with a computer-readable storage medium storing the program.

### Advantageous Effects of Invention

According to the present invention, it is possible to provide an information processing system and the like contributing to accuracy improvement in analysis processing.

### BRIEF DESCRIPTION OF DRAWINGS

FIG. 1 is a block diagram illustrating a configuration of an information processing system 1000 according to a first exemplary embodiment of the present invention.

FIG. 2 is a diagram illustrating one example of a data set according to the first exemplary embodiment of the present invention.

FIG. 3 is a diagram illustrating one example of data stored in a function storage unit 110 according to the first exemplary embodiment of the present invention.

FIG. 4 is a diagram illustrating details of a feature construction unit 120 according to the first exemplary embodiment of the present invention.

FIG. 5 is a diagram illustrating details of a test unit 130 according to the first exemplary embodiment of the present invention.

FIG. 6 is a diagram illustrating details of the test unit 130 according to the first exemplary embodiment of the present invention.

FIG. 7 is a diagram illustrating details of the test unit 130 according to the first exemplary embodiment of the present invention.

FIG. 8 is a flowchart illustrating an operation of the information processing system 1000 according to the first exemplary embodiment of the present invention.

FIG. 9 is a block diagram illustrating a configuration of an information processing system 1001 according to a second exemplary embodiment of the present invention.

FIG. 10 is a diagram illustrating one example of a data set according to the second exemplary embodiment of the present invention.

FIG. 11 is a diagram illustrating one example of data stored by a function storage unit 111 according to the second exemplary embodiment of the present invention.

FIG. 12 is a diagram illustrating details of a feature construction unit 121 according to the second exemplary embodiment of the present invention.

FIG. 13 is a diagram illustrating details of an test unit 131 according to the second exemplary embodiment of the present invention.

FIG. 14 is a block diagram illustrating a configuration of an information processing system 1002 according to a third exemplary embodiment of the present invention.

FIG. 15 is a diagram illustrating one example of a hardware configuration capable of implementing the information processing system according to each of the exemplary embodiments of the present invention.

### DESCRIPTION OF EMBODIMENTS

Initially, to be easily understood, wording used upon detailed description of an information processing system 1000 applicable with the present invention will be defined.

(Data Set)

A “data set” refers to data to be input to the information processing system 1000. The “data set” includes one feature or a plurality of features. The “feature” may be translated into a “variable.”

(Function)

A “function” defines processing of constructing a new feature from a given feature. The “function” is applied to a feature included in a data set. In other words, when the “function” is applied to a feature, processing defined by the function is executed for the feature, and a new feature is constructed as a result.

In other words, the “function” defines an operation applied to a feature. This may be expressed in different words: the function defines processing of transforming a feature into another feature. The “function” may be mapping applied to a feature included in a data set. In other words, a function indicates the above-described operation associated with the function. In other words, a function indicates the above-described processing associated with the function.

The processing defined by the “function” is, for example, a unary operation. The “function” defines an operation such as a trigonometric function (sin(X), cos(X), or tan(X)), a natural logarithm, an absolute value or sign inversion, or the like. The “function” may define an operation with a parameter n, such as, logₙX, Xⁿ.

The processing defined by the “function” is a polynomial operation. The polynomial operation is an operation having a plurality of operands. The “function” defines, for example, an arithmetic operation (addition, subtraction, multiplication, or the like) between a feature X and a feature Y. When the feature X and the feature Y are logical values, the “function” defines, for example, a logical operation (AND, OR, XOR, or the like) applied to a bit value of the feature X and a bit value of the feature Y.

The processing defined by the “function” may be “processing depending on data” in which processing is determined according to data. One specific example of the processing depending on is normalization processing.

The “processing depending on” is described below with a specific example. Suppose that, for example, a data set including information in which values of names and values of heights of 100 persons are correlated has been input to a data mining device. In this case, the data set includes two features including a feature that is “name” and a feature that is “height.” In this example, the feature that is “name” represents the values of the names of the 100 persons. The feature that is “value of height” represents the values of the heights of the 100 persons.

Suppose that the data mining device constructs, by applying a function that defines normalization processing to the feature “height”, a new feature that is “normalized height.” In this case, the data mining device does not individually normalize data for one person included in the feature. Suppose that the data mining device has initially received, for example, only a piece of information “name: N, height: 174” of a first person among pieces of information for the 100 persons. In this case, the data mining device does not calculate a new feature “normalized height” for the piece of information of the first person. The reason is that only when the data mining device completes the pieces of information of the 100 persons, values necessary for normalization as parameters (i.e. an average value of the values of “height” for the 100 persons and a standard deviation of “height” for the 100 persons) become available, and a function for normalization is fixed as a result.

For example, histogram construction, clustering, and Principal Component Analysis are exemplified as other specific examples of such “processing depending on data”.

(Analysis Engine)

An “analysis engine” is analysis processing based on a feature. In other words, the analysis engine receives a feature as an input, executes analysis on the basis of the feature, and outputs the result of analysis. The analysis engine is referred to also as an analysis algorism or the like executed by a data mining device. The analysis engine is an analysis engine that executes processing such as Regression Analysis, Factor Analysis, Covariance Structure Analysis, Principal Component Analysis (Principal Factor Analysis), Discriminant Analysis, Kernel Analysis, Cluster Analysis, or Abnormality Detection. “Designation of a type of an analysis engine” represents reception of a designation of a type of such an analysis engine. The “analysis engine” may indicate, for example, a subject (e.g. a device) that executes the above-described analysis processing or a program that controls a processor to execute analysis processing.

(Constraint Condition)

A constraint condition is a requirement to be satisfied by information output by an analysis engine. In other words, the constraint condition is a requirement to be satisfied by an analysis result output by the analysis engine. When a type of the analysis engine is single regression analysis, one specific example of the constraint condition is that “a chi-square value is equal to or greater than 0.9.”

(Acquiring Information)

Hereinafter, reading out information from a storage device, receiving information from an external device, receiving an input of information from an operator, and the like is collectively described as “acquiring information.”

(Outputting Information)

Hereinafter, writing information to a storage device, transmitting information to an external device, presenting information to an operator in a form of screen display, a sound or the like, and the like is collectively described as “outputting information.”

By taking into consideration the above-described definitions of wording, exemplary embodiments of the present invention will be described in detail with reference to the drawings.

### First Exemplary Embodiment

A first exemplary embodiment is one specific example of the present invention in a case where single regression analysis is designated as a type of the analysis engine.

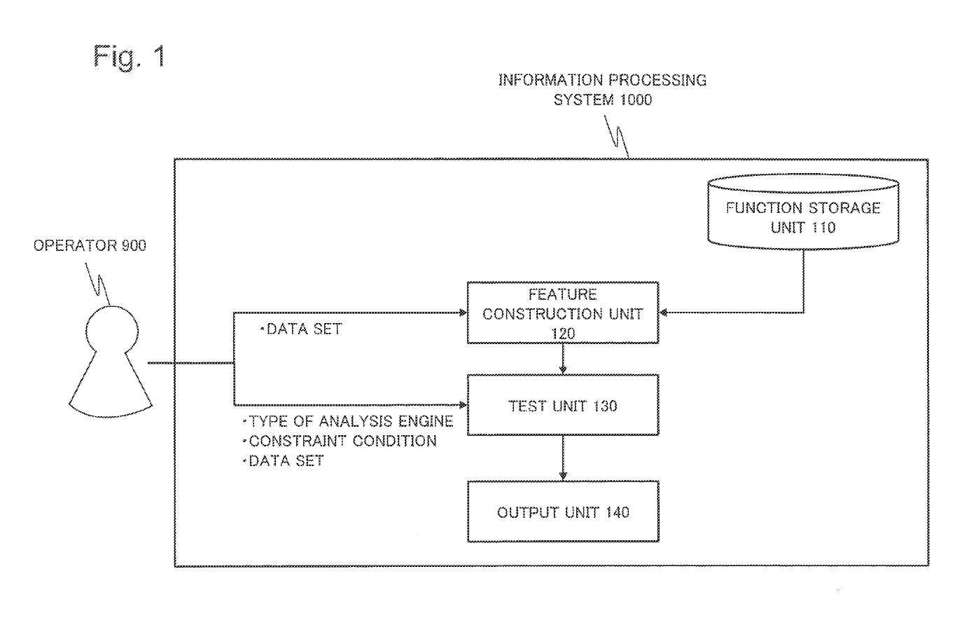

FIG. 1 is a block diagram illustrating an outline of an information processing system 1000 according to the first exemplary embodiment.

The information processing system 1000 includes a function storage unit 110, a feature construction unit 120, a test unit 130, and an output unit 140.

The function storage unit 110 can store one or a plurality of functions. The function storage unit 110 stores at least one function that define an operation (polynomial operation) taking a plurality of operands.

The function storage unit 110 may be implemented inside the information processing system 1000, or may be implemented in an external device, not illustrated, accessible by the information processing system 1000.

The feature construction unit 120 acquires a target data set. The feature construction unit 120 may receive an input of a data set from an operator, or may read out a data set from a storage unit, which is not illustrated. The feature construction unit 120 may receive a data set from a device, not illustrated, provided outside the information processing system 1000.

The feature construction unit 120 acquires a function from the function storage unit 110. The feature construction unit 120 applies the function which is acquired to a feature included in a data set. Accordingly, the feature construction unit 120 constructs a new feature that is a result obtained by applying the function to the feature.

Suppose that the feature construction unit 120 acquires a function that defines a polynomial operation. The function that defines a polynomial operation takes two or more features as input. In this case, the feature construction unit 120 selects a combination of pieces of data of features to be input (operands) to the operation defined by the function among a plurality of pieces of data of features included in a data set. The feature construction unit 120 construct, by applying the function to the selected combination of pieces of data of features, a new feature that is a result obtained by applying the function.

The test unit 130 acquires, from, for example, the operator, a designation of a type of the analysis engine and a designation of the constraint condition.

In the first exemplary embodiment, the test unit 130 acquires “single regression analysis” as the type of the analysis engine. The test unit 130 acquires a designation of, among a plurality of features included in the data set, a feature that is an objective variable to be predicted by a function.

The test unit 130 inputs, as an explanatory variable, the new feature constructed by the feature construction unit 120 to a single regression analysis engine (not illustrated). The test unit 130 acquires a regression equation output by the single regression analysis engine. The test unit 130 tests whether the regression equation satisfies the constraint condition.

The output unit 140 outputs, for example, a regression equation that satisfies the requirement.

Hereinafter, with reference to FIG. 1 to FIG. 7, details of the function storage unit 110, the feature construction unit 120, the test unit 130, and the output unit 140 will be described.

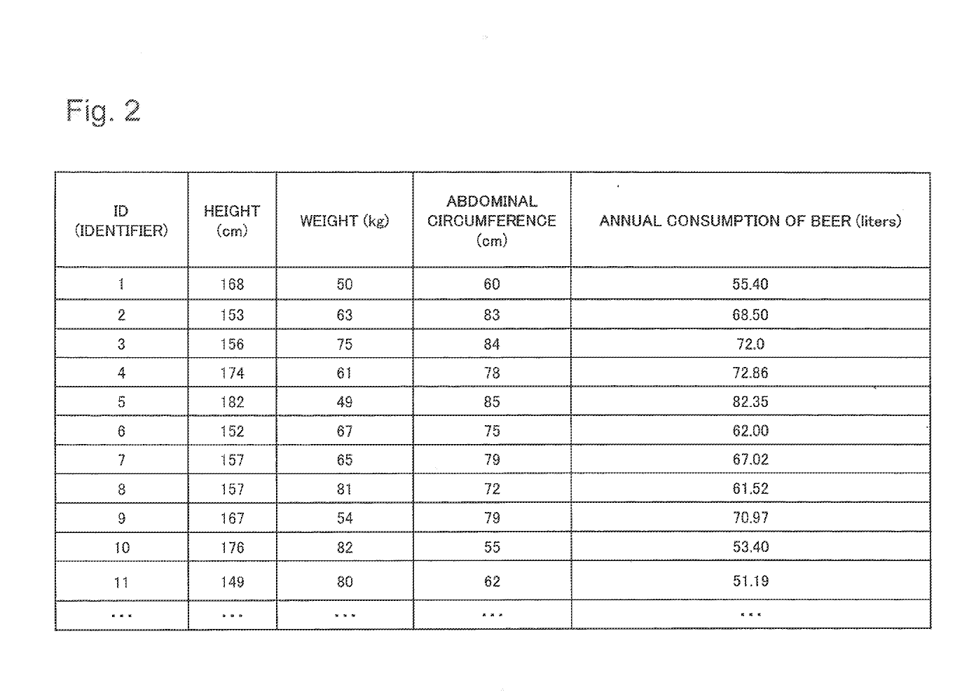

FIG. 2 is a diagram illustrating one example of a data set input to the information processing system 1000 illustrated in FIG. 1. As illustrated in FIG. 2, the data set includes information that correlates, for a plurality of persons, for example, an ID (identifier), a value of height, a value of weight, a value of abdominal circumference, and a value of an annual consumption of beer. Each of “height,” “weight,” “abdominal circumference,” and “annual consumption of beer” illustrated in FIG. 2 is equivalent to the “feature.” The data set illustrated in FIG. 2 is a data set prepared for description, and is not a set of measured values obtained from test subjects.

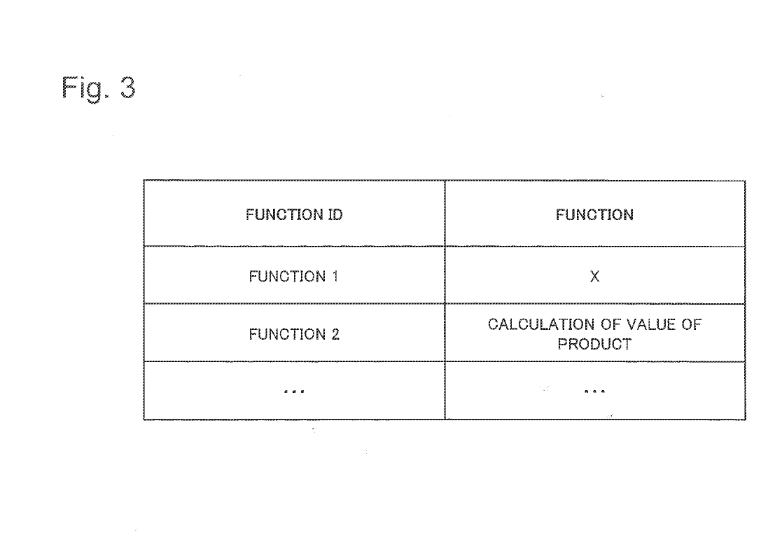

FIG. 3 is a diagram illustrating one example of data stored in the function storage unit 110 illustrated in FIG. 1. As illustrated in FIG. 3, a plurality of functions are stored in the function storage unit 110.

As illustrated in FIG. 3, processing defined by a function the function ID (identifier) of which is “function 1” is X. Here, X represents identity mapping. Processing defined by a function the function ID of which is “function 2” is processing of calculating a value of the product of a value of a first feature and a value of a second feature. In the following description, a function is indicated by a function ID of the function. For example, “function 2” indicates a function the function ID of which is “function 2.”

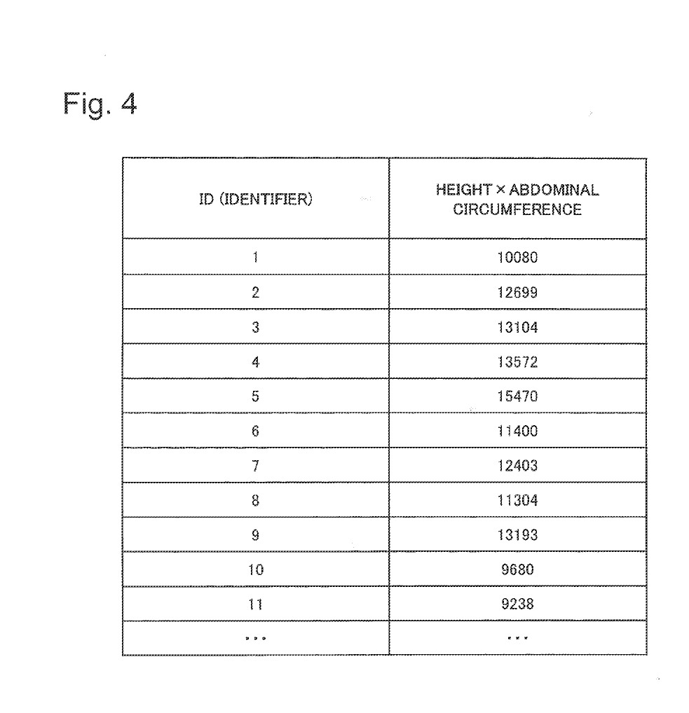

With reference to FIG. 1 and FIG. 4, details of the feature construction unit 120 illustrated in FIG. 1 are described below. As illustrated in FIG. 1, an operator 900 inputs, for example, a data set to the feature construction unit 120. As described above, a plurality of features are included in the data set. The operator 900 may further input a designation of a feature that is an objective variable to the feature construction unit 120. The feature construction unit 120 acquires a data set as a target. The feature construction unit 120 may further acquire a designation of a feature that is an objective variable. The feature construction unit 120 may read out a data set from a storage device, which is not illustrated. The feature construction unit 120 may receive a data set from a device, which not illustrated, that is communicable with the information processing system 1000 and is not included in the information processing system 1000.

Suppose that, for example, the feature construction unit 120 acquires, as a feature that is an objective variable, a designation of a feature that is “annual consumption of beer.” Suppose that, for example, the feature construction unit 120 reads out the function 2 (i.e. calculation of a value of a product) from the function storage unit 110. The feature construction unit 120 selects features to be input to the function from features (i.e. “height,” “weight,” and “abdominal circumference”) other than the objective variable, among a plurality of features included in the data set. In the following description, the features selected as features to be input to the function are referred to as “n” and “m.”

Considering that, in multiplication that is an operation defined by the function 2, a result to be output is unchanged even when an order of the operation is changed, ₃C₂ (=3) ways of combinations of n and m are conceivable. In other words, two features of n and m are selected from three features that are “height,” “weight,” and “abdominal circumference,” and therefore 3C2=3 ways result. Three combinations are listed below.

n m

height weight

height abdominal circumference

weight abdominal circumference

The feature construction unit 120 executes operations of (1) and (2) described below for each of combinations (in this case, three combinations) of selected features.

(1) The feature construction unit 120 inputs a combination of selected features as operands to the function 2.

(2) The feature construction unit 120 obtains a result obtained by applying the function 2 to the combination of the selected features and sets the result as a new feature.

Consequently, the feature construction unit 120 newly constructs the following three features.

height times weight

height times abdominal circumference

abdominal circumference times weight

However, the feature construction unit 120 does not have to construct all of the three new features described above.

FIG. 4 is a diagram illustrating one specific example of a feature which is newly constructed. A feature that is “height times abdominal circumference” illustrated in FIG. 4 is a new feature constructed as a result obtained by the feature construction unit 120 applying the function 2 to a combination of a feature that is “height” and a feature that is “abdominal circumference”.

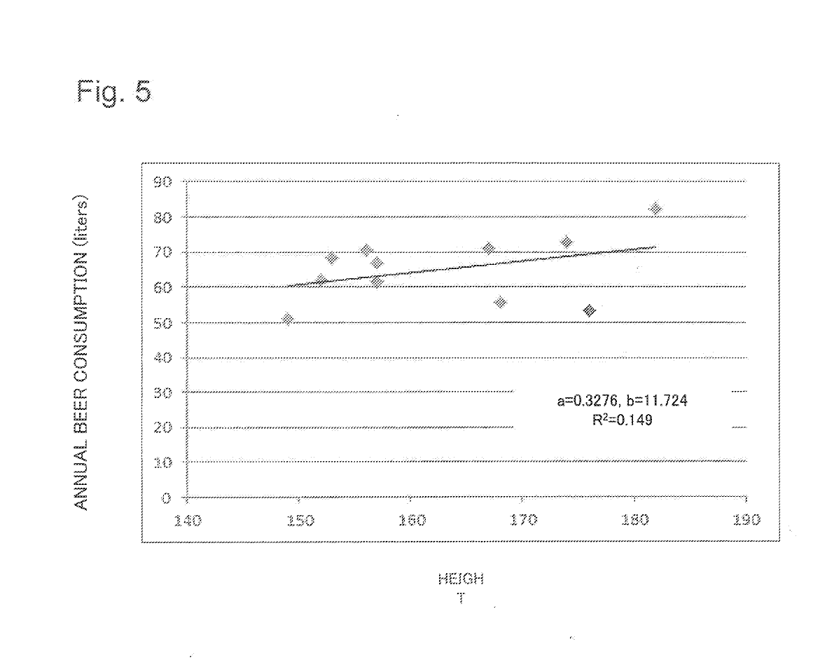

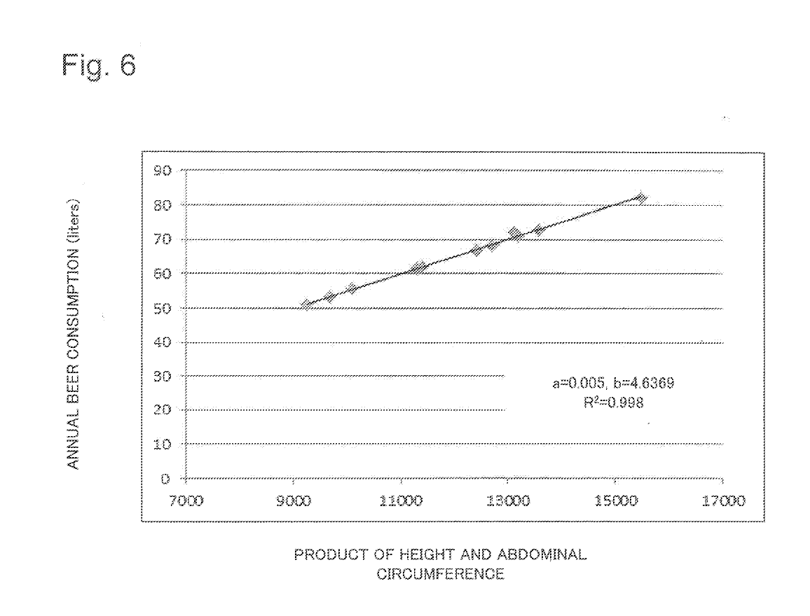

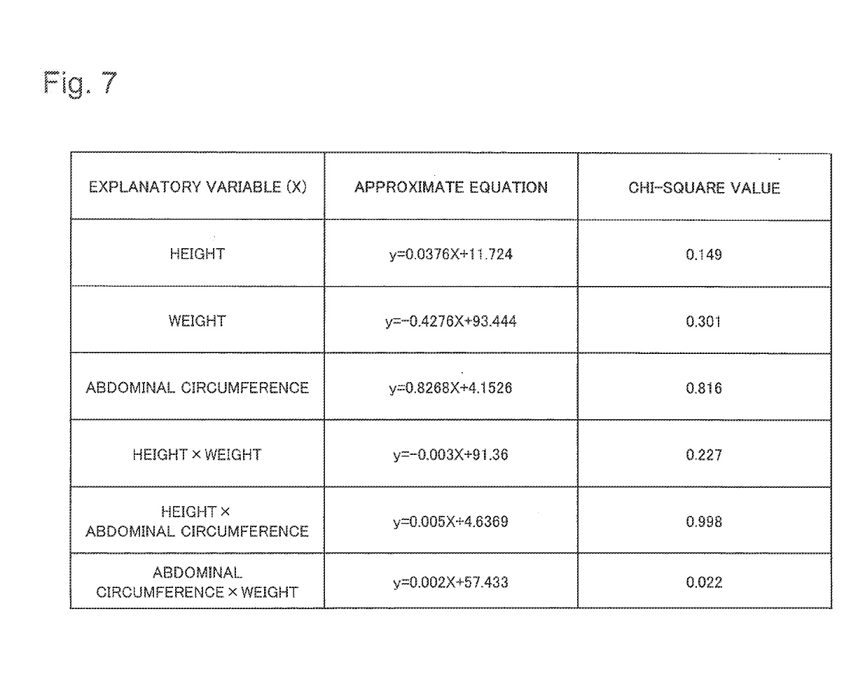

Details of the test unit 130 illustrated in FIG. 1 are described below with reference to FIG. 1, FIG. 5, FIG. 6, and FIG. 7. The following description is merely one specific example of an operation of the test unit 130, and the operation of the test unit 130 is not interpreted restrictively.

Suppose that the test unit 130 acquires “single regression analysis” as a type of the analysis engine, acquires “annual consumption of beer” as a feature that is an objective variable, and acquires a condition that is “a chi-square value is equal to or greater than 0.9” as a constraint condition.

In other words, the test unit 130 executes regression analysis according to an equation that is Y (annual consumption of beer)=aX+b. Here, Y is an objective variable. X is an explanatory variable. Symbols a and b are constants.

The test unit 130 analyzes an extent how well a feature (explanatory variable) output by the feature construction unit 120 can explain the annual consumption of beer (objective variable).

The test unit 130 acquires features (“height,” “weight,” and “abdominal circumference”) from the feature construction unit 120. The test unit 130 acquires features (“height times weight,” “height times abdominal circumference,” and “abdominal circumference times weight”) constructed by the feature construction unit 120.

The test unit 130 selects one feature from a plurality of acquired features. Suppose that the test unit 130 selects, for example, a feature that is “height.”

FIG. 5 is a graph illustrating a result obtained by the test unit 130 selecting a feature that is “height” as an explanatory variable and executing single regression analysis on the basis of the explanatory variable. As illustrated in FIG. 5, as the result of the single regression analysis, a result that is a=0.3276 and b=11.724 is obtained and a chi-square value is 0.149.

FIG. 6 is a graph illustrating a result obtained by the test unit 130 selecting a feature that is “height times abdominal circumference” as an explanatory variable and executing single regression analysis on the basis of the explanatory variable. As illustrated in FIG. 6, as the result of the single regression analysis, a result that is a=0.005 and b=4.637 is obtained and a chi-square value is 0.998.

The test unit 130 executes, for each acquired feature, processing of inputting a feature to an analysis engine (in the example described above, a single regression analysis engine), processing of acquiring an analysis result (i.e. a regression equation and a chi-square value) output by the analysis engine, and processing of testing whether the analysis result (i.e. the chi-square value) satisfies the constraint condition.

FIG. 7 is a diagram illustrating a result obtained by the test unit 130 executing processing for each of the six types of features acquired by the test unit 130. As illustrated in FIG. 7, an explanatory variable satisfying the constraint condition, “a chi-square value is equal to or greater than 0.9,” is only “height times abdominal circumference.”

The fact that a chi-square value satisfies the constraint condition when “height times abdominal circumference” is selected as the explanatory variable means that it is possible to explain an individual annual consumption of beer according to a relational equation that is Y=aX+b on the basis of a value of the product of a value of height and a value of abdominal circumference.

In contrast, as illustrated in other examples of FIG. 7, when another feature is selected as the explanatory variable, the chi-square value does not satisfy an test threshold. This means that it is not possible to explain an individual annual consumption of beer according to a relational equation that is Y=aX+b on the basis of a value of another feature.

The output unit 140 outputs, for example, a regression equation satisfying the requirement.

The output unit 140 may operate as described below. Suppose that the constraint condition is satisfied by an analysis result obtained by an analysis engine to which, for example, a feature A described below:

feature A is: a value of the product of a value of a feature B and a value of a feature C.

Suppose that the feature B is, for example, a value of height and the feature C is, for example, a value of weight. At that time, the output unit 140 may output information that “pre-processing that should be performed is calculating the product of a value of a feature that is height and a value of a feature that is weight.” Alternatively, the output unit 140 may output information that “when a feature that is ‘the product of a value of a feature that is height and a value of a feature that is weight’ is input to a designated analysis engine, an analysis result satisfying a constraint condition is obtained.” Alternatively, the output unit 140 may output information that is “the product of a value of a feature that is height and a value of a feature that is weight.” The output unit 140 may output such information together with a type of a designated analysis engine and a file name of a data set.

Next, an operation of the information processing system 1000 according to the first exemplary embodiment is described.

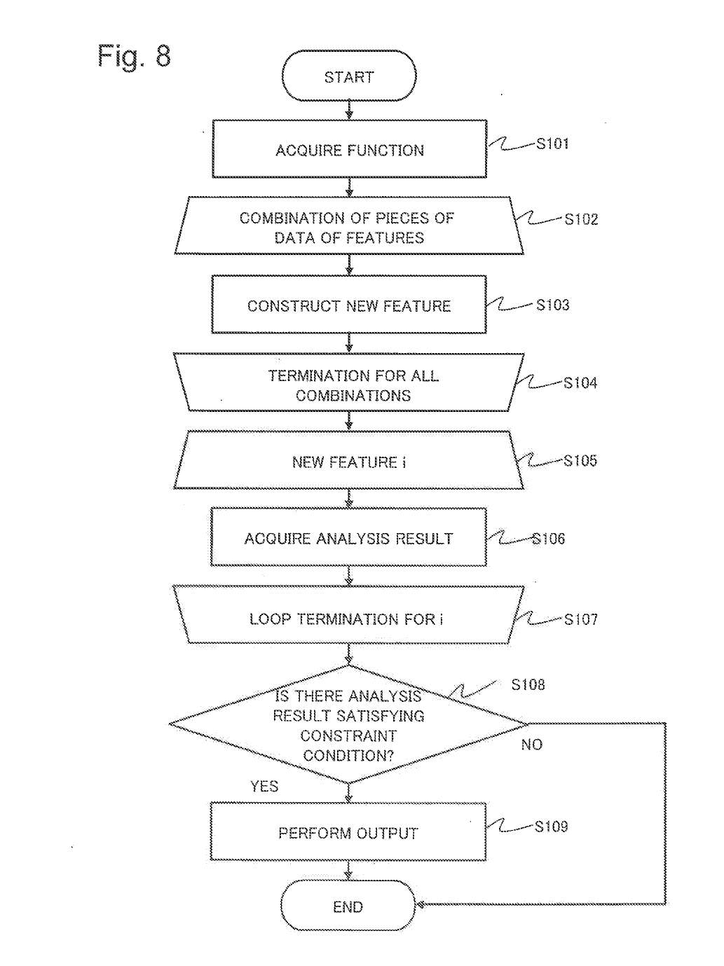

FIG. 8 is a flowchart illustrating the operation of the information processing system 1000 according to the first exemplary embodiment.

The feature construction unit 120 acquires one function from the function storage unit 110 (Step S101). The feature construction unit 120 selects a combination of features that are operands in an operation defined by the function from among a plurality of features included in a data set (Step S102). The feature construction unit 120 inputs the combination of features, which is selected, to the function, and calculates, as a new feature, a value output according to the function (Step S103). The operation shown in Step S103 may be expressed in other words: applying the function to the combination of features, which is selected, and constructing a new feature that is a result obtained by applying the function to the combination of features, which is selected. The feature construction unit 120 constructs new features, for example, for all of the combinations of features that can be operands in the function (Step S104).

The test unit 130 selects, from a plurality of new features, a specific feature (Step S105). The test unit 130 analyzes an extent how well a designated objective variable can be explained on the basis of the specific feature (explanatory variable). As a result, the test unit 130 obtains an analysis result (i.e. a regression equation and a chi-square value) (Step S106). The test unit 130 repeats the operation shown in Step S106 for all of the features constructed by the feature construction unit 120 (step S107).

The test unit 130 tests whether an analysis result satisfying the constraint condition is obtained (Step S108). The operation shown in Step S108 may be executed during repetition from Step S105 to Step S107.

When an analysis result satisfying the constraint condition is obtained (YES in Step S108), the output unit 140 outputs the analysis result satisfying the constraint condition (Step S109). When an analysis result satisfying the constraint condition is not obtained (NO in Step S108), the output unit 140 does not output an analysis result satisfying the constraint condition.

An operation and an effect produced by the information processing system 1000 according to the first exemplary embodiment are described below. According to the first exemplary embodiment, it is possible to provide the information processing system 1000 that contributes to precision enhancement in analysis processing.

The reason is that the feature construction unit 120 according to the first exemplary embodiment calculates a function for a feature, and constructs a new feature.

Owing to such a configuration, the information processing system 1000 “is able to increase the number of features that are candidates for an explanatory variable.” This may be rephrased as: it is possible to “increase the number of candidates for a feature for verifying a hypothesis.” Such an operation increases a possibility that an explanatory variable sufficiently explaining an objective variable is selected, and achieves an advantageous effect that accuracy in data mining is improved.

In the example described above, features input from an operator 900, i.e. features included in a data set are of four types (“height,” “weight,” “abdominal circumference,” and “annual consumption of beer”). In the example, one of the four types of features (i.e. “annual consumption of beer”) is designated as an objective variable. In this case, substantial candidates for an explanatory variable are three types of features (“height,” “weight,” and “abdominal circumference”) other than the annual consumption of beer.

The information processing system 1000 constructs, as described above, new features (i.e. “height times weight,” “weight times abdominal circumference,” and “height times abdominal circumference”) on the basis of three types of features included in a data set and a function stored in the function storage unit 110.

Thus the information processing system 1000 can improve accuracy in data mining because of an increase of a possibility that a feature sufficiently explaining an objective variable is selected by increasing the number of features that are candidates for an explanatory variable.

The information processing system 1000 according to the first exemplary embodiment can output procedures of pre-processing that should be executed for a feature in order to improve accuracy of data mining. The reason is that, when obtaining an analysis result satisfying a constraint condition, the output unit 140 according to the first exemplary embodiment outputs a feature input to an analysis engine to obtain the analysis result. Alternatively, the reason is that the output unit 140 outputs information showing processing which should be executed for a feature included in a data set in order to obtain an analysis result satisfying a constraint condition.

The information processing system 1000 according to the first exemplary embodiment can reduce quantity of work of an analysis engineer who executes data analysis. The reason is that the feature construction unit 120 of the information processing system 1000 according to the first exemplary embodiment constructs a new feature on the basis of a plurality of features. And the test unit 130 of the information processing system 1000 selects, among constructed new features, a feature that meets a predetermined standard. In other words, the test unit 130 inputs, for example, a new feature which is constructed to an analysis engine that executes analysis processing on the basis of a feature which is input. And, the test unit 130 tests whether information output by the analysis engine satisfies a predetermined requirement. When, for example, the information which is output satisfies the predetermined requirement, the test unit 130 selects the feature that is input to the analysis engine. The predetermined requirement (i.e. constraint condition) means that, for example, a correlation with an objective variable is higher than a predetermined standard. In other words, when an analysis engineer inputs a plurality of features to the information analysis system 1000, the information processing system 1000 can automatically or semi-automatically construct a feature highly correlated with the objective variable.

Specifically, according to, for example, the information processing system 1000 of the first exemplary embodiment, even when the analysis engineer does not know that there is a strong correlation between an “individual annual consumption of beer” and “a value of the product of a value of height and a value of abdominal circumference,” the analysis engineer is able to obtain an analysis result with high accuracy. The reason is that on the basis of a feature that is “height” and a feature that is “abdominal circumference,” the information processing system 1000 constructs a new feature that is “a value of the product of a value of height and a value of abdominal circumference.” In other words, when the analysis engineer inputs a feature that is “height” and a feature that is “abdominal circumference” to the information processing system 1000, the information processing system 1000 can construct a feature highly correlated with an objective variable, i.e. “a value of the product of a value of height and a value of abdominal circumference” automatically or semi-automatically for the user.

According to the information processing system 1000 of the first exemplary embodiment, an analysis engineer who executes data analysis can notice that there is a strong correlation between an objective variable and a feature which is newly constructed. For example, the analysis engineer who executes data analysis can notice that there is a strong correlation between an “individual annual consumption of beer” and “a value of the product of a value of height and a value of abdominal circumference.” The reason is that the output unit 140 outputs a feature which is newly constructed and information indicating that an analysis result satisfying a constraint condition is obtained by inputting the feature. The output unit 140 outputs, for example, information in which “when a feature that is ‘the product of a value of a feature that is height and a value of a feature that is weight’ is input to a designated analysis engine, an analysis result satisfying a constraint condition is obtained.” Thus the information processing system 1000 is able to be used to support the analysis engineer to find an explanatory variable strongly correlated with an objective variable.

### Modification Examples of First Exemplary Embodiment

The test unit 130 may receive a designation of multi-regression analysis as a type of the analysis engine. Suppose that, for example, the test unit 130 receives a designation of multi-regression analysis (Z=aX+bY+c). Here, Z is an objective variable. X is a first explanatory variable. Y is a second explanatory variable. Symbols a, b, and c each are constants.

Suppose that, for example, the test unit 130 acquires six features from the feature construction unit 120. In this case, the number of ways of selecting a combination of the first explanatory variable X and the second explanatory variable Y is 15 (=(6 times 5) divided by 2). The test unit 130 repeats the operation of Step S106 illustrated in FIG. 8 for 15 combinations of the explanatory variables.

Further, the test unit 130 may receive curvilinear regression analysis as a type of the analysis engine. In this case, the test unit 130 receives a designation of a type of a curve such as an exponential function or a Gaussian function.

The modification examples described above are also applicable to other exemplary embodiments.

### Second Exemplary Embodiment

A second exemplary embodiment is one specific example of the present invention in a case where discriminant analysis is designated as a type of the analysis engine.

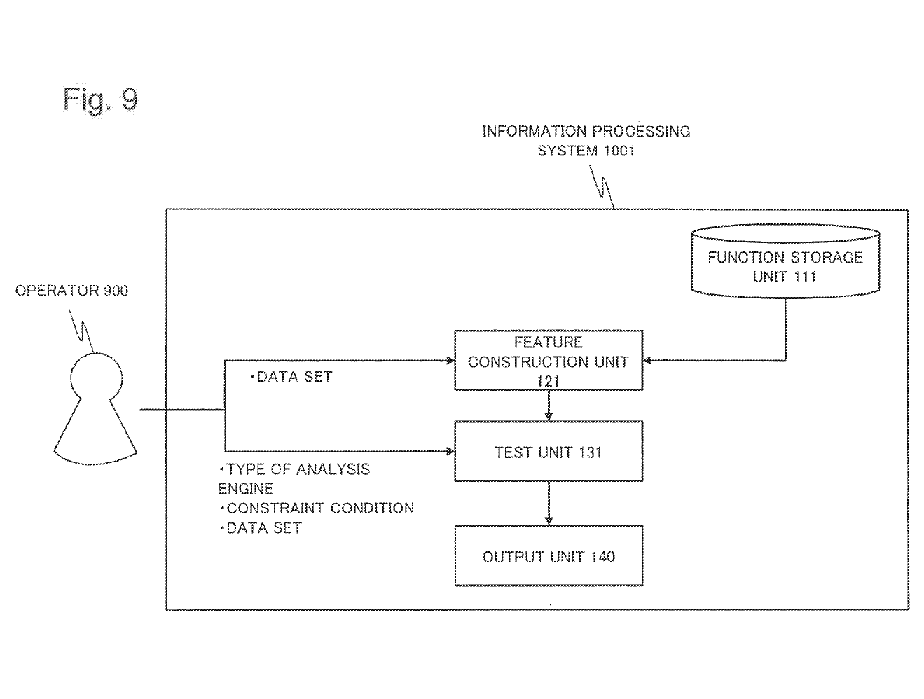

FIG. 9 is a block diagram illustrating a configuration of an information processing system 1001 according to the second exemplary embodiment. As illustrated in FIG. 9, the information processing system 1001 according to the second exemplary embodiment may have the following configuration.
Including a function storage unit 111 instead of the function storage unit 110 according to the first exemplary embodiment.
Including a feature construction unit 121 instead of the feature construction unit 120.
Including a test unit 131 instead of the test unit 130.

The first exemplary embodiment and the second exemplary embodiment are different in a data set to be handled and a type of the analysis engine to be designated.

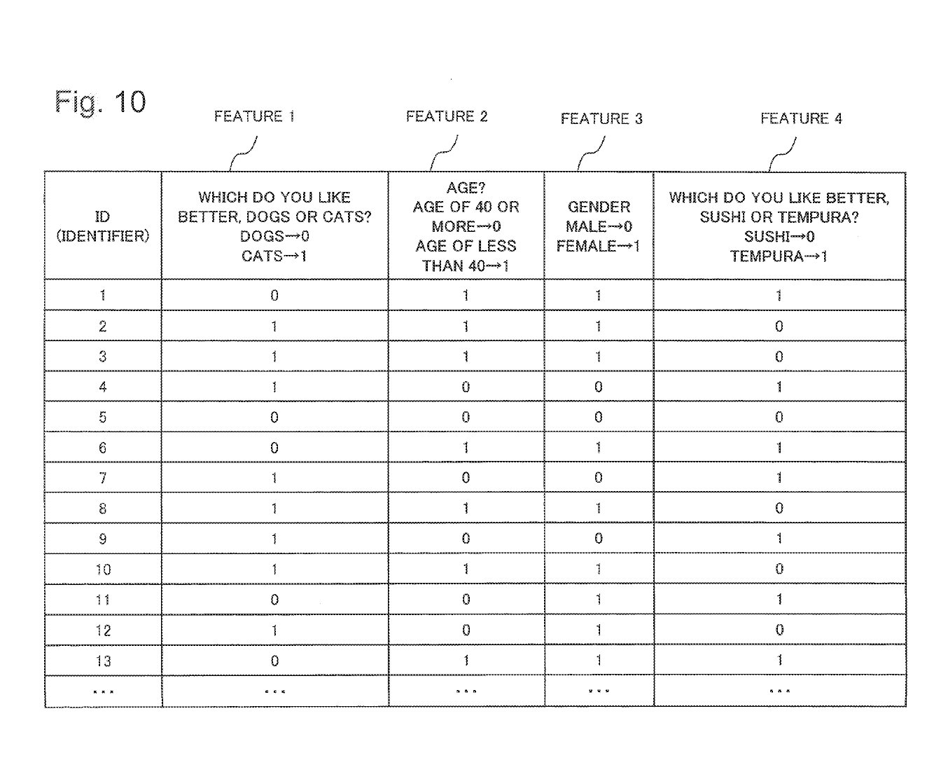

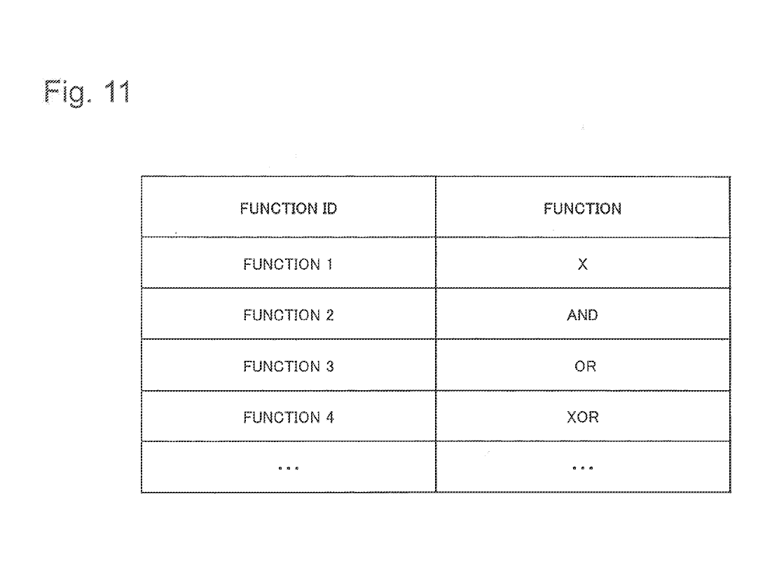

FIG. 10 is a diagram illustrating one example of a data set input to the information processing system 1001 illustrated in FIG. 9. The data set illustrated in FIG. 10 may be also referred to in another way as multivariable data. As illustrated in FIG. 10, the data set includes information that correlates a feature 1 to a feature 4 with each identifier for a plurality of persons. The data set illustrated in FIG. 11 is data representing, for example, answer results of a questionnaire for the plurality of persons. Each feature is an answer to a question item included in the questionnaire. The contents of the feature 1 to the feature 4 are listed below. Specifically, the question item and the value indicated by the answer are listed for each of the features.

Feature 1: Which do you like better, dogs or cats? (Dogs are indicated by 0 and cats are indicated by 1),

Feature 2: Age? (An age of 40 or more is indicated by 0 and an age of less than 40 is indicated by 1),

Feature 3: Gender? (A male is indicated by 0 and a female is indicated by 1), and

Feature 4: Which do you like better, sushi or tempura? (Sushi is indicated by 0 and tempura is indicated by 1).

FIG. 11 is a diagram illustrating one example of information stored in the function storage unit 111 illustrated in FIG. 9. As illustrated in FIG. 11, the function storage unit 111 stores the functions 1 to 4. The function 1 defines identity mapping X. The function 2 defines a logical product (AND) operation for values of two features. The function 3 defines a logical sum (OR) operation for values of two features. The function 4 defines an exclusive OR (XOR) for values of two features.

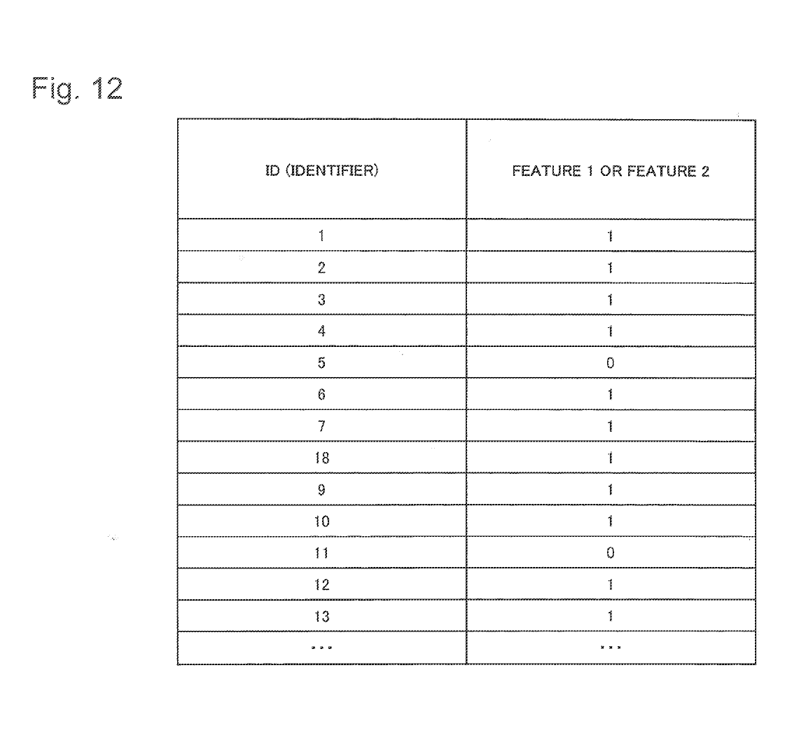

Details of the feature construction unit 121 illustrated in FIG. 9 are described below with reference to an example illustrated in FIG. 12. FIG. 12 is a diagram illustrating one specific example with respect to a new feature constructed by the feature construction unit 121.

The feature construction unit 121 selects one function from a plurality of functions stored in the function storage unit 111. The feature construction unit 121 selects a combination of features from a plurality of features included in an data set which is input. Suppose that, for example, the feature construction unit 121 selects “OR” as a function and, in addition, selects the feature 1 and the feature 2 as features. FIG. 12 illustrates new features constructed by the feature construction unit 121 as the result.

The feature construction unit 121 constructs new features, for example, for all of the combinations that is capable of being operands for the function among the combinations of a plurality of features included in the data set. The feature construction unit 121 does not have to construct new features for all of the combinations.

Return to the description referring to FIG. 9. Here, suppose that “discriminant analysis” is designated as information on a type of the analysis engine for the test unit 131. Suppose that the feature 4 (i.e. “which of sushi and tempura is preferred”) as an objective variable for the test unit 131.

Suppose that the test unit 131 receives a condition that is “a concordance rate is equal to or greater than 95%” as a constraint condition (i.e. a requirement that should be satisfied by information output by the analysis engine). The “concordance rate” is an index indicating a degree of concordance between values of a selected feature and values of a feature designated as a prediction target.

The test unit 131 analyzes whether “which of sushi and tempura is preferred” can be sufficiently explained on the basis of the new features constructed by the feature construction unit 121.

Details of the test unit 131 are described below. The test unit 131 acquires new features constructed by the feature construction unit 121. The test unit 131 selects one feature from a plurality of features which are acquired. Suppose that, for example, the test unit 131 selects a feature that is the “feature 3.”

The test unit 131 calculates a concordance rate between values of the selected feature and values of a feature designated as a prediction target.

Referring to FIG. 10, in the data for 13 persons illustrated, a value of the feature 3 is in concordance with a value of the feature 4 for data of five persons. Therefore, a concordance rate between values of the feature 3 and values of the feature 4 is 0.38 (=5/13). The number of persons whose data is used to calculate the concordance rate may be designated, for example, in advance.

The test unit 131 calculates a concordance rate with values of the objective variable “which of sushi and tempura is preferred” for all of the features which are acquired.

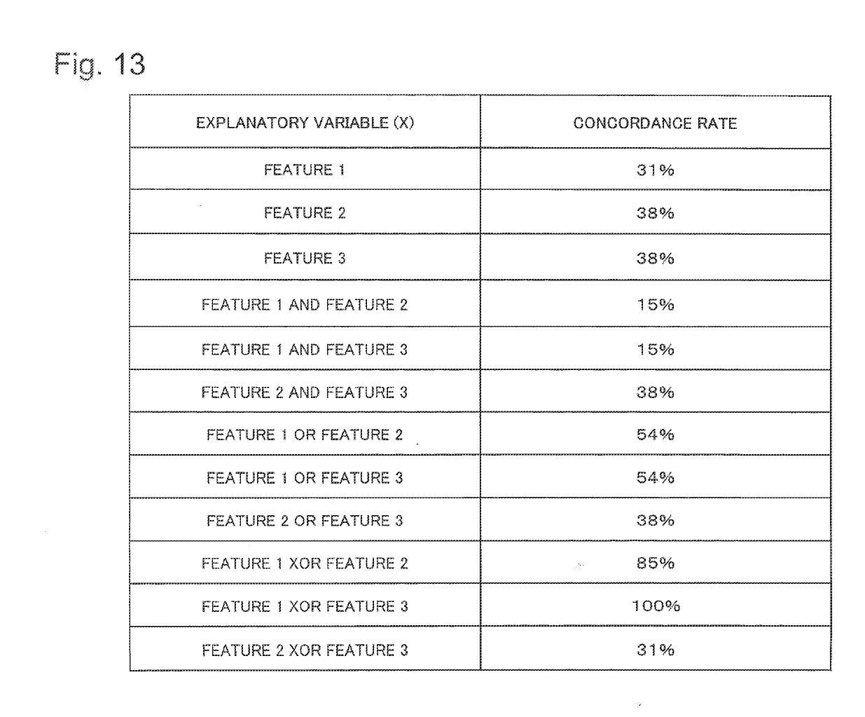

FIG. 13 is a diagram illustrating results of processing executed by the test unit 131 for the features constructed by the feature construction unit 121. As illustrated in FIG. 13, a concordance rate between values obtained by applying exclusive OR (XOR) to the feature 1 and the feature 3 and values of the feature 4 is 100%, which satisfies the constraint condition. In other words, this shows that the preference for “sushi” or “tempura” can be explained on the basis of the values of exclusive OR XOR between the “feature 1” and the “feature 3” in the questionnaire results.

An operation and an effect produced by the information processing system 1001 according to the second exemplary embodiment are described below. According to the second exemplary embodiment, it is possible to provide the information processing system 1001 that contributes to accuracy improvement in analysis processing.

The reason is that the feature construction unit 121 according to the second exemplary embodiment applies a function to a feature, and thereby constructs a new feature.

Owing to such a configuration, the information processing system 1000 has an advantageous effect that is “increasing the number of features that are candidates for an explanatory variable.” This may be translated as: “increasing the number of candidates for a feature to verify a hypothesis.” Such an operation increases a possibility that an explanatory variable sufficiently explaining an objective variable is selected, and achieves an advantageous effect that accuracy in data mining is improved.

The information processing system 1001 according to the second exemplary embodiment can output procedures of pre-processing that should be executed for a feature in order to improve accuracy of data mining. The reason is that, when obtaining an analysis result satisfying a constraint condition, the output unit 140 according to the second exemplary embodiment outputs a feature input to an analysis engine to obtain the analysis result. Alternatively, the reason is that the output unit 140 outputs information showing processing which should be executed for a feature included in a data set in order to obtain an analysis result satisfying a constraint condition.

### Third Exemplary Embodiment

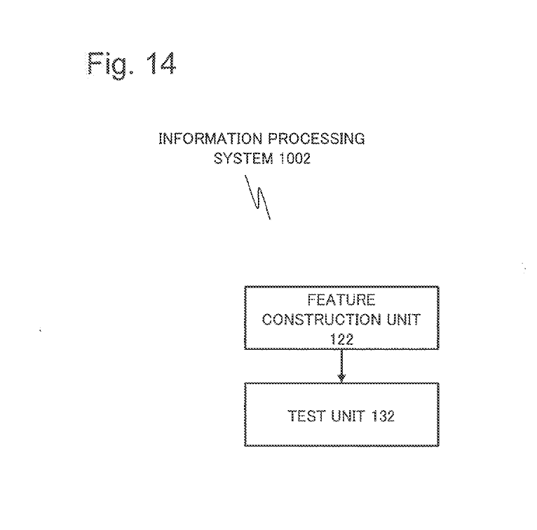

FIG. 14 is a block diagram illustrating a configuration of an information processing system 1002 according to a third exemplary embodiment. As illustrated in FIG. 14, the information processing system 1002 includes a feature construction unit 122 and a test unit 132.

The feature construction unit 122 selects, for a function that defines an operation taking a plurality of operands, a combination of features to be the plurality of operands from a plurality of input features, and constructs, by applying the function to the combination of the features, a new feature that is a result obtained by applying the function to the combination of the features.

The test unit 132 inputs the new feature to an analysis engine that executes analysis processing on the basis of the features, and tests whether information output by the analysis engine satisfies a predetermined requirement.

According to the third exemplary embodiment, it is possible to provide the information processing system 1002 that contributes to accuracy improvement in analysis processing.

<Hardware Configuration of Information Processing System>

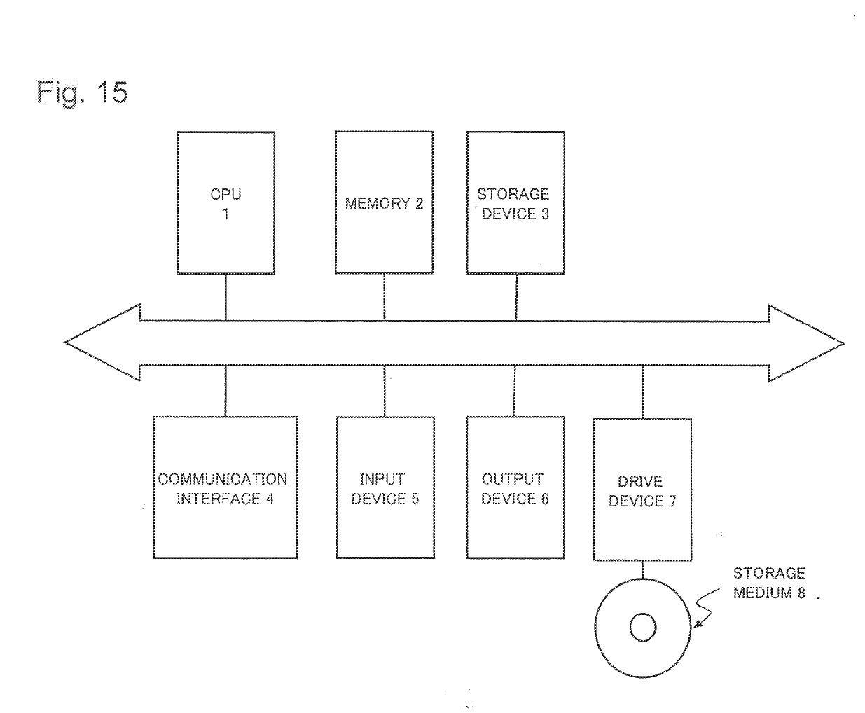

FIG. 15 is a diagram illustrating a hardware configuration of a computer with which the information processing system 1000 according to the first exemplary embodiment is able to be implemented. The computer illustrated in FIG. 15 includes a CPU (Central Processing Unit) 1, a memory 2, a storage device 3, and a communication interface (I/F) 4. The computer illustrated in FIG. 15 may further include an input device 5 or an output device 6. A function of the information processing system 1000 is achieved, for example, by the CPU 1 executing a computer program (a software program, hereinafter, described simply as a “program”) loaded into the memory 2. In execution, the CPU 1 appropriately controls the communication interface 4, the input device 5, and the output device 6.

The present invention described using, as examples, the exemplary embodiments described above may be achieved with a non-volatile storage medium 8 such as a compact disc storing the program. The program stored in the storage medium 8 is read out, for example, by a drive device 7.

Communication performed by the information processing system 1000 is achieved by an application program controlling the communication interface 4 by using a function provided by, for example, an OS (Operating System). The input device 5 is, for example, a keyboard, a mouse, or a touch panel. The output device 6 is, for example, a display. The information processing system 1000 may be achieved with two or more physically separated devices communicably connected with one another by cable, wireless, or a combination thereof.

The example of the hardware configuration illustrated in FIG. 15 is applicable to the other exemplary embodiments described above. The information processing system according to each of the exemplary embodiments of the present invention may be a dedicated device. The hardware configurations of the information processing system according to each of the exemplary embodiments of the present invention and each function block thereof are not limited to the above configuration.

### Other Modification Examples

The analysis engine that executes analysis processing does not have to be implemented in the identical device that is the information processing system 1000. The analysis engine may only be implemented in a device accessible from the information processing system 1000. The above-described modification examples are applicable to other exemplary embodiments.

As described above, the present invention has been described by exemplifying cases where single regression analysis, multi-regression analysis, and discriminant analysis are designated as a type of the analysis engine.

The present invention is not limited to the exemplary embodiments described above and can be carried out in various modes. The present invention is also applicable to data mining using an analysis engine other than the types exemplified in the exemplary embodiments.

The exemplary embodiments described above can be carried out in appropriate combinations. The present invention is not limited to the exemplary embodiments described above and can be carried out in various modes.

The block division illustrated in each of the block diagrams is a configuration illustrated for convenience of explanation. The present invention described using each of the exemplary embodiments as an example is, regarding implementation thereof, not limited to the configuration illustrated in each of the block diagram.

While exemplary embodiments to carry out the present invention have been described, the exemplary embodiments are intended for understanding the present invention easily, and are not intended for construing the present invention limitedly. It should be understood that the present invention can be modified and improved without departing from its spirit and the present invention includes equivalents thereof.

This application is based upon and claims the benefit of priority from U.S. patent application 61/883,672, filed on Sep. 27, 2013, the disclosure of which is incorporated herein in its entirety by reference.

### INDUSTRIAL APPLICABILITY

The present invention described using the above-described exemplary embodiments as examples can be used for, for example, a tool supporting data mining.

### REFERENCE SIGNS LIST

1 CPU
2 Memory
3 Storage device
4 Communication interface
5 Input device
6 Output device
7 Drive device
8 Storage medium
110 Function storage unit
111 Function storage unit
120 Feature construction unit
121 Feature construction unit
122 Feature construction unit
130 Test unit
131 Test unit
132 Test unit
140 Output unit
900 Operator
1000 Information processing system
1001 Information processing system
1002 Information processing system

1. An information processing system comprising:
a memory storing a set of instructions; and
at least one processor configured to execute the set of instructions to:
select, for a function that defines an operation taking a plurality of operands, a combination of features that are capable being the plurality of operands from a plurality of features which are input, and construct, by applying the function to the combination of the features, a new feature that is a result obtained by applying the function to the combination of the features; and
input the new feature to an analysis engine that executes analysis processing on a basis of the features, and test whether information output by the analysis engine satisfies a predetermined requirement.

2. The information processing system according to claim 1, wherein
the at least one processor is configured to:
receive a selection of an analysis engine, receive an input of a requirement satisfied by information output by the analysis engine, and input the new feature to the selected analysis engine.

3. The information processing system according to claim 1, wherein
the at least one processor is configured to:
select, from the plurality of features, a plurality of combinations of the features, and
execute processing of constructing a plurality of new features by applying the function to each combination of features among the plurality of combinations of the features; and
execute, for each of the plurality of the new features,
processing of inputting a specific feature to the selected analysis engine among the plurality of new features,
processing of acquiring information output by the analysis engine, and
processing of testing whether the information which is acquired satisfies the requirement.

4. The information processing system according to claim 1, wherein
the at least one processor is configured to:
output information that satisfies the requirement in information output by the analysis engine.

5. The information processing system according to claim 1, further comprising:
the at least one processor is configured to:
output, when the information output by the analysis engine satisfies the requirement, a feature input to the analysis engine to obtain the information output by the analysis engine, or a combination of a function applied to construct the feature and a feature to which the function is applied.

6. The information processing system according to claim 1, wherein
the function defines a binary operation.

7. The information processing system according to claim 1, wherein
the function defines an arithmetic operation or a logic operation for the features.

8. The information processing system according to claim 1, wherein
the at least one processor is configured to:
receive a designation of any of the features as an objective variable, and receive a number designation of explanatory variables as the requirement when regression analysis is selected as an analysis engine.

9. An information processing method performed by a computer, the method comprising:
acquiring a function from a function storage unit, the computer being capable of accessing the function storage unit storing the function, the function defining an operation taking a plurality of operands;
selecting a combination of features that are capable of being the plurality of operands from a plurality of features which are input, and constructing, by applying the function to the combination of the features, a new feature that is a result obtained by applying the function to the combination of the features; and
inputting the new feature to an analysis engine that executes analysis processing on a basis of the features, and testing whether information output by the analysis engine satisfies a predetermined requirement.

10. A non-transitory computer-readable recording medium storing a program causing a computer to execute:
processing of acquiring a function from a function storage unit, the computer being capable of accessing the function storage unit storing the function, the function defining an operation taking a plurality of operands;
processing of selecting a combination of features that are capable of being the plurality of operands from a plurality of features which are input, and constructing, by applying the function to the combination of the features, a new feature that is a result obtained by applying the function to the combination of the features; and
processing of inputting the new feature to an analysis engine that executes analysis processing on a basis of the features, and testing whether information output by the analysis engine satisfies a predetermined requirement.

11. An information processing system comprising:
feature construction means for selecting, for a function that defines an operation taking a plurality of operands, a combination of features that are capable being the plurality of operands from a plurality of features which are input, and constructing, by applying the function to the combination of the features, a new feature that is a result obtained by applying the function to the combination of the features; and
test means for inputting the new feature to an analysis engine that executes analysis processing on a basis of the features, and testing whether information output by the analysis engine satisfies a predetermined requirement.
